(19) United States
(12) Patent Application Publication
(10) Pub. No.: US 2009/0139354 A1
(43) Pub. Date: Jun. 4, 2009

(54) VIBRATING ASSEMBLY FOR A VIBRATION EXERCISER

(76) Inventor: Mu-Chuan WU, Tainan Hsien (TW)

Correspondence Address: BACON & THOMAS, PLLC, 625 SLATERS LANE, FOURTH FLOOR, ALEXANDRIA, VA, 22314-1176, US

(21) Appl. No.: 12/366,168

(22) Filed: Feb. 5, 2009

Related U.S. Application Data
(63) Continuation-in-part of application No. 11/698,826, filed on Jan. 29, 2007.

(51) Int. Cl. F16H 21/46

(52) U.S. Cl. 74/25

(57) ABSTRACT

A vibrating assembly for a vibration exerciser has a base, a drive device, a transmission, multiple stanchions and a platform. The drive device is mounted on the base and has a drive wheel. The transmission has a drive axle, two rotary cranks, two reciprocating cranks, two base levers and two platform levers. The drive axle is mounted rotatably on the base and connected to the drive wheel and has two ends. The rotary cranks are respectively mounted on the ends of the drive axle. The reciprocating cranks are pivotally connected to the rotary cranks. The levers have moving ends mounted on corresponding reciprocating cranks and stationary ends. The stationary ends of the base levers are attached to the base. The stationary ends of the platform levers are attached to the platform. The stanchions are attached to the base and have guide rods telescopically protruding therefrom and attached to the platform.

The present invention is a continuation-in-part of application No 11/698,826, filed on Jan. 29, 2007.

### BACKGROUND THE INVENTION

1. Field of the Invention

The present invention relates to a vibrating assembly, and more particularly to a vibrating assembly for a vibration exerciser with improved efficiency and cheaper.

2. Description of Related Art

A conventional vibration exerciser has a vibrating assembly to provide a vibrating effect to a person who steps, sits or lies on or abuts the vibrating assembly for training or exercising muscles.

With reference to FIGS. 7 to 9, a conventional vibrating assembly for vibration exerciser comprises a base (14), multiple stanchions (13), a platform (12) and a vibration generator (10).

The stanchions (13) are securely attached perpendicularly to the base (14) and each stanchion (13) has a platform mount (131) and a resilient device (132) mounted between the platform mount (131) and the stanchion (13).

The platform (12) is mounted on the platform mounts (131) of the stanchions (13) and has an inner surface.

The vibration generator (10) is securely mounted on the inner surface of the platform (12) and has a connection frame (11) and a reciprocating device (15). The connection frame (11) is securely mounted on the inner surface of the platform (12). The reciprocating device (15) is mounted securely on the connection frame (11) and comprises a motor and eccentrically mounted disc, thus causing eccentric motion with a centrifugal force (C).

In use, a person having a mass inducing a load (L) stands on the platform (12), an amplitude of vibration (A) of the platform (12) is directly proportional to a resultant force (ΣF), defined as ΣF=C−L. Therefore, as L increases, the ΣF becomes smaller so a lower A is achieved. Therefore, the amplitude (A) alters according to the mass of the person standing on the platform (12). Moreover, as the reciprocating device (15) is mounted on the platform (12) and the platform (12) is only supported by the stanchions (13), due to centrifugal force of the motor and the way of the motor mounted cause the platform (12) to be vibrated in X-, Y- and not vibrate only in Z-directions.

Therefore, with reference to FIG. 10A to 10D, in another conventional vibrating assembly for a vibration exerciser comprises a base (25), multiple stanchions (24) mounted on the base (25), a platform mount (23) telescopically mounted on the stanchion (24), a vibration generator (20) and a platform (23). The vibration generator (20) comprises a drive device having a drive wheel (21) mounted securely on the drive device and a connection bar (22) connected eccentrically to the drive wheel (21) and mounted pivotally on an inner surface of the platform (23). The amplitude of vibration is dependent on mass of the person and the platform, since the drive device must directly work against the load caused by the mass of the person and the platform, the drive device need deliver more power and expensive.

Furthermore. with reference to FIG. 11, in a further conventional vibrating assembly for a vibration exerciser, each stanchion (24A) is mounted on a base (25A) and has a pivot mount (241A) and a platform mount (242A) disposed adjacent to the stanchion (24A) and mounted securely on the platform (23A), and a vibration generator (20A) comprises a drive device (21A) mounted on the base (25A), a transmission and a connection lever (22A). The transmission is mounted on the base (25A) and has two eccentric shafts. The eccentric shafts are rotatably connected to and driven by the drive device (21A). The connection levers (22A) are respectively and pivotally mounted on the pivot mounts (241A) of the stanchions (24A) and are connected to corresponding eccentric shafts at one end and respectively to the platform mounts (242A) at the other ends. Although the platform (23A) can be vibrated by the drive device (21A), a vibrating force is rigidly transmitted to the platform (23A) by the rigid connection levers (22A) and the drive device (21A) must be powerful to drive the eccentric shafts so may make the person feel uncomfortable and be easily injured by jerking, additionally the drive device (21A) is expensive to run.

To overcome the shortcomings, the present invention tends to provide a vibrating assembly for a vibration exerciser to mitigate or obviate the aforementioned problems.

### SUMMARY OF THE INVENTION

The main objective of the invention is to provide a vibrating assembly, and more particularly to a vibrating assembly for a vibration exerciser having improved efficiency and cheaper.

A vibrating assembly for a vibration exerciser in accordance with the present invention has a base, a drive device, a transmission, multiple stanchions and a platform. The drive device is mounted on the base and has a drive wheel. The transmission has a drive axle, two rotary cranks, two reciprocating cranks, two base levers and two platform levers. The drive axle is mounted rotatably on the base and connected to the drive wheel and has two ends. The rotary cranks are respectively mounted on the ends of the drive axle. The reciprocating cranks are pivotally connected to the rotary cranks. The levers have moving ends mounted on corresponding reciprocating cranks and stationary ends. The stationary ends of the base levers are attached to the base. The stationary ends of the platform levers are attached to the platform. The stanchions are securely attached to the base and have guide rods telescopically protruding therefrom and attached to the platform.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a vibrating assembly for a vibration exerciser in accordance with the present invention;

FIG. 2 is an enlarged, partially exploded perspective view of the vibrating assembly in FIG. 1;

FIG. 3 is an enlarged top view of tie vibrating assembly, in FIG. 1, shown without a platform;

FIG. 4 is an enlarged side view in partial section of the vibrating assembly in FIG. 1;

FIG. 5 is an operational side view of the vibrating assembly in FIG. 4, showing platform displacement;

FIGS. 6A to 6D are operational side representations of the vibrating assembly in FIG. 1 showering platform displacement;

FIG. 7 is a partially exploded perspective view of a vibrating assembly for a vibration exerciser in accordance with the prior art;

FIG. 8 is a side view in partial section of the vibrating assembly in FIG. 7;

FIG. 9 is an operational side view of the vibrating assembly in FIG. 7;

FIGS. 10A to 10D are operational side views of another vibrating assembly for a vibration exerciser in accordance with the prior art;

FIG. 11 is an exploded perspective view of a further vibrating assembly for a vibration exerciser in accordance with the prior art.

### DETAILED DESCRIPTION OF PREFERRED EMBODIMENT

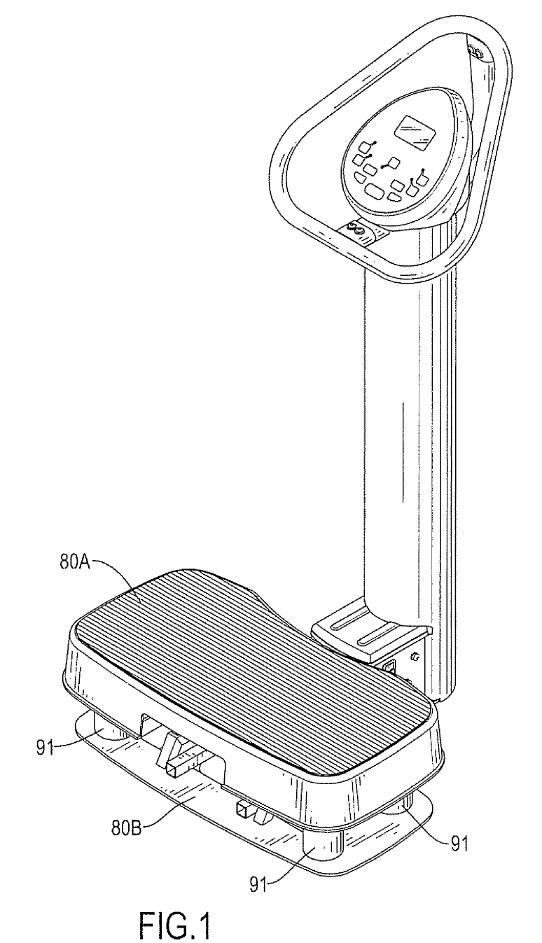

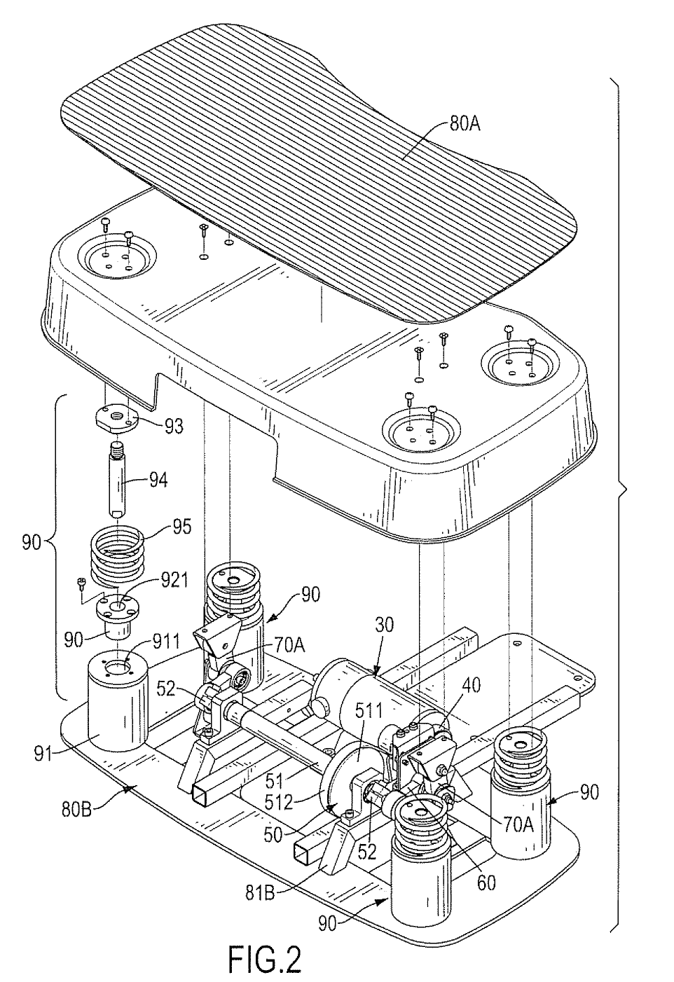

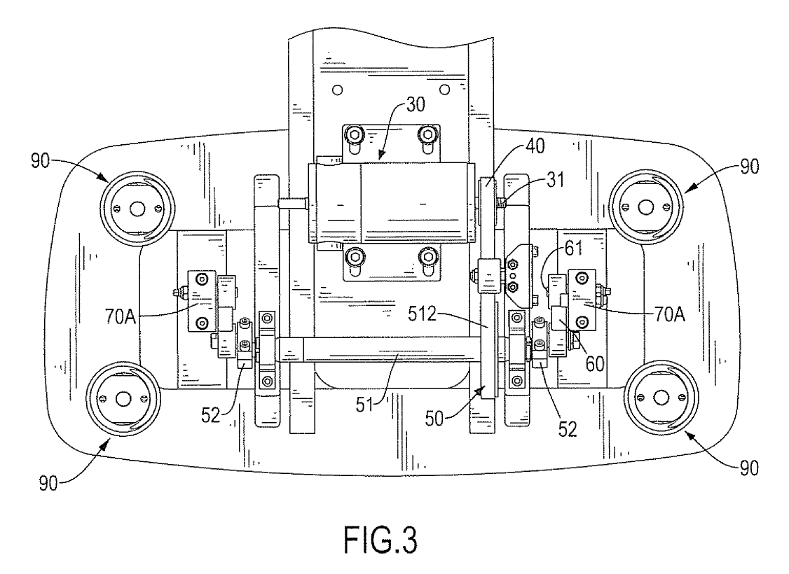

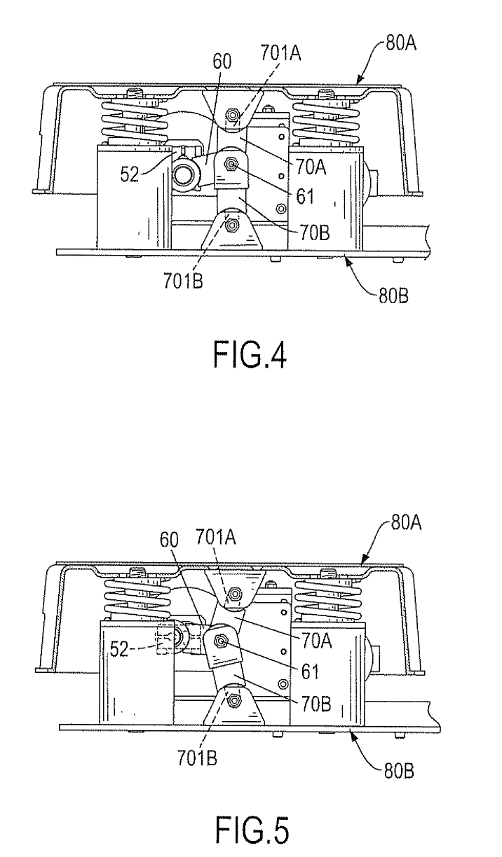

With reference to FIGS. 1 to 4, a vibrating assembly for a vibration exerciser in accordance with the present invention comprises a base (80B), a drive device (30), a transmission (50), multiple stanchions (90) and a platform (80A).

The base (80B) may be rectangular and has an inner surface, an outer surface, four corners and a mounting frame (81B). The mounting frame (81B) is centrally mounted securely on the base (80B). The outer surface of the base (80B) may comprise multiple non-slip feet to stabilize the base (80B).

The drive device (30) is eccentrically attached to the base (80B), may be mounted on the mounting frame (81B) and has a drive shaft (31) and a drive wheel (40). The drive wheel (40) is mounted on the drive shaft (31) of the drive device (30).

The transmission (50) is connected to the drive device (30) and has a drive axle (51), two rotary cranks (52), two reciprocating cranks (60), two base levers (70B) and two platform levers (70A).

The drive axle (51) is mounted rotatably on the base (80B), may be mounted rotatably through the mounting frame (81B) of the base (80B), may be parallel with the drive device (30) and has two ends, a driven wheel (511) and a belt (512). The belt (512) is mounted around and connects the drive and driven wheels (40, 511). The rotary cranks (52) are respectively and securely mounted on the ends of the drive axle (51).

The reciprocating cranks (60) are respectively and pivotally connected to the rotary cranks (52) of the transmission (50) and each reciprocating crank (60) has a lever end and a pintle (61). Each pintle (61) is transversely attached to, may be formed on or mounted on, the lever end of a corresponding reciprocating crank (60).

The base levers (70B) are connected to the base (80B), are respectively and pivotally connected to the reciprocating cranks (60) and each base lever (70B) has a stationary end (701B) and a moving end (702B), The stationary ends (701B) of the base levers (70B) are connected pivotally to the base (80B) and may be connected to the mounting frame (81B). The moving ends (702B) of the base levers (70B) are respectively and pivotally connected to the reciprocating cranks (60) and may be via the pintles (61).

The platform levers (70A) are respectively and pivotally connected to the reciprocating cranks (60) and each platform lever (70A) has a moving end (702A) and a stationary end (701A). The moving ends (702A) of the platform levers (70A) are respectively and pivotally connected pivotally to the reciprocating cranks (60) and may be via the pintles (61).

The stanchions (90) are securely attached to, may be mounted or formed on, and protrude from the inner surface of the base (80B), may be respectively adjacent to the corners of the base (80B) and each stanchion (90) has a mounting cylinder (91), a bushing (92), a guide rod (94), a positioning disc (93) and a resilient element (95).

The mounting cylinders (91) are attached securely to, may be mounted on or formed, and protrude from the inner surface of the base (80B), may be respectively adjacent to the corners of the base (80B) and each mounting cylinder (91) has a distal end and a rod hole (911). The rod hole (911) is formed through the distal end of the mounting cylinder (91).

The bushing (92) is mounted securely on the distal end of the mounting cylinder (91), may be in the rod hole (911) and has a guide hole (921). The guide hole (921) is formed through the bushing (92) and communicates with the rod hole (911) of the mounting cylinder (91).

The guide rod (94) is movably mounted in the rod hole (911) of the mounting cylinder (91) and the guide hole (921) of the bushing (92) and has a proximal end and an optional outer thread. The proximal end of the guide rod (94) may be thinner than the guide rod (94) and protrudes from the mounting cylinder (91). The outer thread is formed around the proximal end of the guide rod (94).

The positioning disc (93) is mounted on the proximal end of the guide rod (94) and may have a threaded hole. The threaded hole is formed through the positioning disc (93) and is screwed on the outer thread of the guide rod (94).

The resilient element (95) may be a compression spring, is mounted around the guide rod (94) and may abut the positioning disc (93) and the bushing (92).

The platform (80A) is mounted above the base (80B) and covers the drive device (30) and transmission (50), is connected to the stanchions (90) via the guide rods (94) and the positioning discs (93) and has an outer surface and an inner surface. The proximal ends of the guide rods (94) are mounted through the outer surface from the inner surface of the platform (80A) and are connected securely to the platform (80A). The positioning discs (93) of the stanchions (90) are connected securely to the platform (80A) with fasteners, such as bolts. The inner surface of the platform (80A) is connected securely to the stationary ends of the platform levers (70A) and abuts the resilient elements (95) so the resilient elements (95) support the platform (80A). The outer surface of the platform (80A) may comprise a grip pad having multiple resilient ribs, protrusions or the like for comfort and stability of a person standing on the platform (80A).

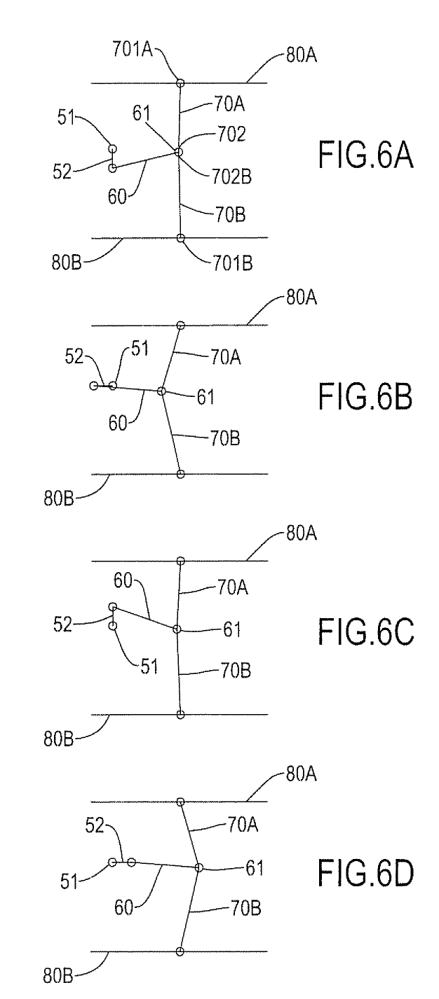

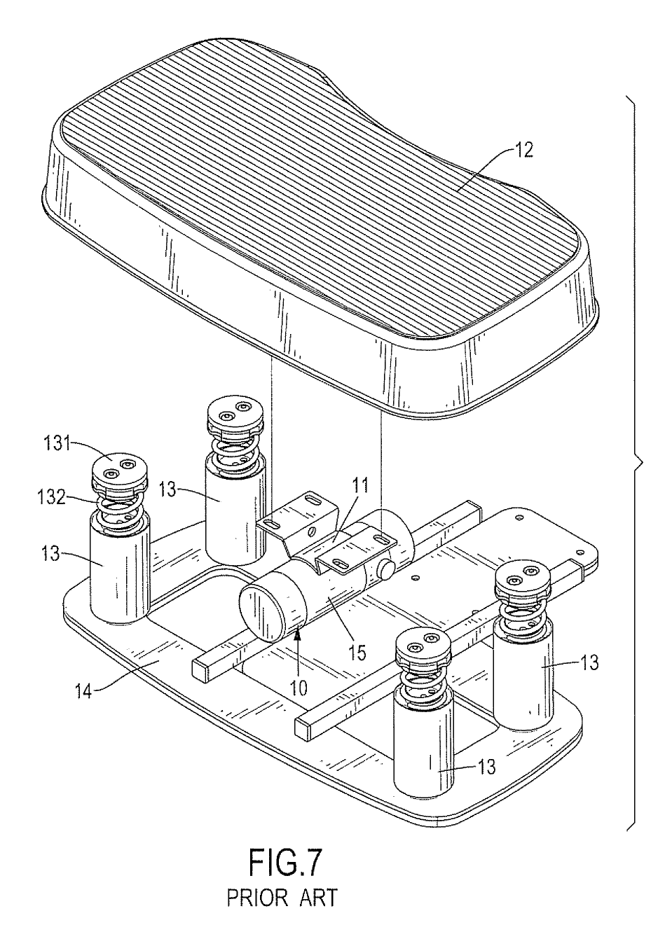

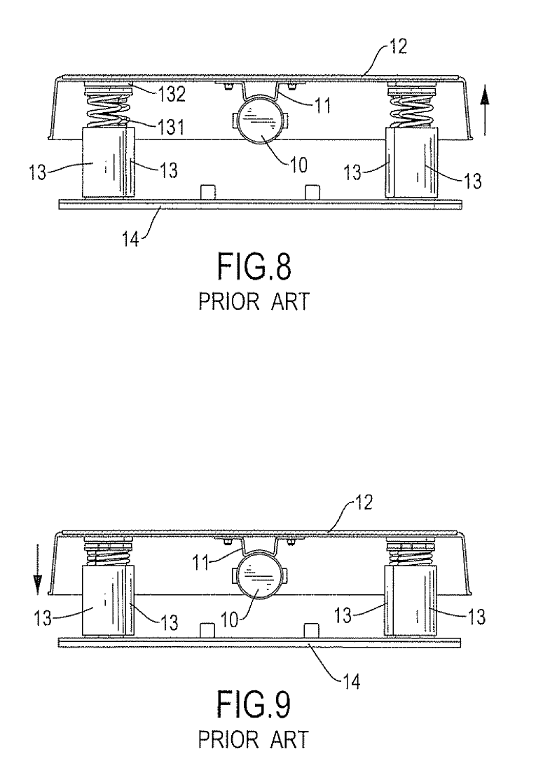

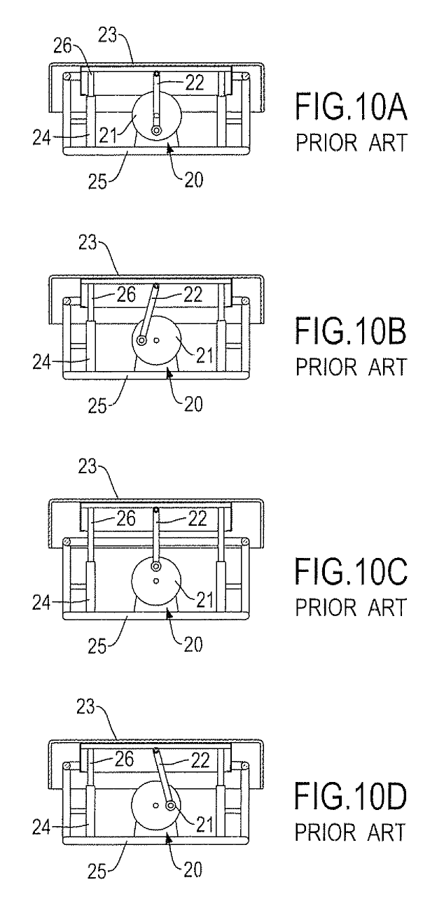

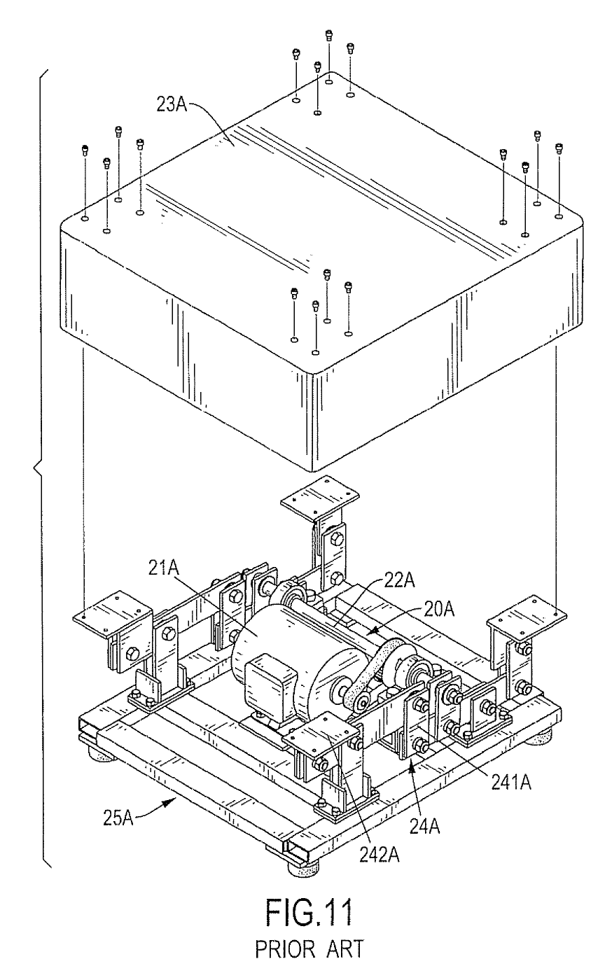

With further reference to FIGS. 5 to 6D, when using the vibrating assembly for a vibration exerciser in accordance with the present invention, the person stands on the platform (80A), then the drive device (30) is actuated to rotate the drive shaft (31) and the drive wheel (40), such motion is transferred by the belt (512) to the drive axle (511) to rotate the rotary cranks (60). Circular movement of the rotary cranks (52) causes the reciprocating cranks (60) to move reciprocally, so forcing the moving ends of the levers (70A, 70B) to move parallelly relative to the base (80B). Since the platform (80A) is prevented from movement parallel to the base (80B) by the guiding rods (94) of the stanchions (90), the platform (80A) is moved up and down steadily

Further, since the drive device (30) use leverage and is aided by the resilient elements (95), the drive device (30) requires less power so reducing manufacturing and use costs.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vibrating assembly for a vibration exerciser having
a base having
an inner surface;
an outer surface;
four corners; and
a mounting frame being centrally mounted securely on the base;
a drive device being eccentrically attached to the base, being mounted on the mounting frame and having
a drive shaft; and
a drive wheel being mounted on the drive shaft of the drive device;
a transmission being connected to the drive device and having
a drive axle being mounted rotatably on the base, bring mounted rotatably through the mounting frame of the base parallel with the drive device and having
two ends;
a driven wheel; and
a belt being mounted around and connecting the drive and driven wheels;
two rotary cranks being respectively and securely mounted on the ends of the drive axle;
two reciprocating cranks being respectively and pivotally connected to the rotary cranks of the transmission and each reciprocating crank having
a lever end; and
a pintle being transversely attached to the lever end of a corresponding reciprocating crank;
two base levers being connected to the base, being respectively and pivotally connected to the reciprocating cranks, and each base lever having
a stationary end being connected pivotally to the mounting frame of the base; and
a moving end being connected to the pintle of a corresponding reciprocating crank; and
two platform levers being respectively and pivotally connected to the reciprocating cranks and each platform lever having
a moving end being connected pivotally to the pintle of a corresponding reciprocating cranks; and
a stationary end;
multiple stanchions being securely mounted on and protruding from the inner surface of the base and each stanchion having
a mounting cylinder being mounted on and protruding from the inner surface of the base adjacent to the corners and each mounting cylinder having a distal end;
a bushing being mounted securely on the distal end of the mounting cylinder;
a guide rod being movably mounted the mounting cylinder and the bushing and having a proximal end protruding from the mounting cylinder;
a positioning disc being mounted on the proximal end of the guide rod; and
a resilient element being mounted around the guide rod between the positioning disc and the bushing; and
a platform being mounted above the base and covering the drive device and transmission, being connected to the stanchions via the guide rods and the positioning discs and having
an outer surface; and
an inner surface being connected securely to the stationary ends of the platform levers and abutting the resilient elements.

2. The vibrating assembly for a vibration exerciser as claimed in claim 1, wherein each resilient element is a compression spring.

3 The vibrating assembly for a vibration exerciser as claimed in claim 2, wherein
each mounting cylinder further has a rod hole formed through the distal end of the mounting cylinder;
each bushing is mounted securely in the rod hole of a corresponding mounting cylinder and has a guide hole formed through the bushing and communicating with the rod hole of the corresponding mounting cylinder; and
each guide rod is movably mounted in the rod hole of the mounting cylinder and the guide hole of the bushing.

4. The vibrating assembly for a vibration exerciser as claimed in claim 3, wherein
each guide rod further has an outer thread being formed around the proximal end of the guide rod near the top end; and
each positioning disc further has a threaded hole being formed through the positioning disc and being screwed on the outer thread of the guide rod.

5. The vibrating assembly for a vibration exerciser as claimed in claim 4, wherein the base is rectangular.

6. The vibrating assembly for a vibration exerciser as claimed in claim 4, wherein the proximal ends of the guide rods are mounted through the outer surface from the inner surface of the platform to connect securely to the platform and the positioning discs are connected securely to the platform with fasteners.

7. The vibrating assembly for a vibration exerciser as claimed in claim 1, wherein
each mounting cylinder further has a rod hole formed through the distal end of the mounting cylinder;
each bushing is mounted securely in the rod hole of a corresponding mounting cylinder and has a guide hole formed through the bushing and communicating with the rod hole of the corresponding mounting cylinder; and
each guide rod is movably mounted in the rod hole of the mounting cylinder and the guide hole of the bushing.

8. The vibrating assembly for a vibration exerciser as claimed in claim 1, wherein
each guide rod further has an outer thread being formed around the proximal end of the guide rod near the top end; and
each positioning disc further has a threaded hole being formed through the positioning disc and being screwed on the outer thread of the guide rod.

9. The vibrating assembly for a vibration exerciser as claimed in claim 1, wherein the proximal ends of the guide rods are mounted through the outer surface from the inner surface of the platform to connect securely to the platform and the positioning discs are connected securely to the platform with fasteners.
